(19) United States
(12) Patent Application Publication
(10) Pub. No.: US 2015/0012866 A1
(43) Pub. Date: Jan. 8, 2015

(54) Method for Data Input of Touch Panel Device

(71) Applicant: Wen-Fu Chang, Hsinchu City (TW)

(72) Inventor: Wen-Fu Chang, Hsinchu City (TW)

(21) Appl. No.: 13/974,493

(22) Filed: Aug. 23, 2013

(30) Foreign Application Priority Data
Jul. 5, 2013 (TW) 102124277

(51) Int. Cl. G06F 3/0488; G06F 3/0482; G06F 3/0484; G06F 3/0481

(52) U.S. Cl. CPC G06F 3/04886; G06F 3/04817; G06F 3/0482; G06F 3/04842
USPC 715/773

(57) ABSTRACT

Disclosed is a method for data input of a touch panel device provided for inputting the input key. The method includes following steps of: determining an area region limiter on the touch panel; defining a plurality of subregion area elements for the area region limiter with respect to positions related to the area region limiter; obtaining a determined result by determining whether a finger sliding operation has been sliding through the subregion area elements; determining one subregion area elements from the plurality of the subregion area elements in accordance with the determined result; displaying input key elements belonging to the determined subregion area element; and selecting an input key from the displayed input key elements as an input data. Thereby a data of the input key can be rapidly input with less probability of input fault.

### FIELD OF THE INVENTION

The present invention relates to a method for data input, and more particularly to a method for data input of a touch panel device.

### BACKGROUND OF THE INVENTION

With the development of technology, a touch panel has been broadly used as an operating interface for a variety of touch panel devices of computers, including desktop computers, notebooks, and tablet computers, and of mobile devices, including cellular phones and personal digital assistant devices.

The touch panel is used for detecting a touching position of an object, such as a finger or a touch pen, that touches the surface of the touch panel. There are allocated with a plurality of touching areas on the touch panel, where each touching area corresponds to a symbol key for allowing a user to input the symbol key into the touch panel device by touching the specific touching area.

Since there are various kinds of standard input keys, it requires a lot of number of symbol keys to be allocated in a touch panel of the touch panel device. With regard to the limited size of the touch panel, in a prior art a user needs to operate a touch panel by alternatively touching specific area between several pages for displaying the symbol key that is desired. It is complicated and is thus always need to take a lot of time.

### SUMMARY OF THE INVENTION

In view of the description above, in prior art it requires a lot of steps for selecting and switching the display between different input pages for symbol key input. It wastes time and moreover the hardware resource of the touch panel device is also wasted as well. Therefore, it becomes an important issue to establish a new method for inputting symbol keys in a touch panel device.

Accordingly, an aspect of the present invention is to provide a method for data input of a touch panel device to solve the problems.

The method of the present invention includes steps of (a) determining an area region limiter on the touch panel; (b) defining a plurality of subregion area elements for the area region limiter with respect to positions related to the area region limiter; (c) obtaining a determined result by determining whether a finger sliding operation has been sliding through the subregion area elements; (d) determining one subregion area elements from the plurality of the subregion area elements in accordance with the determined result; (e) displaying input key elements belonging to the determined subregion area element; and (f) selecting an input key from the displayed input key elements as an input data.

According to an embodiment of the present invention, the shape of the area region limiter is in shape as being selected from a group including frame-shaped form, strip-shaped form, and spot-shaped form.

According to an embodiment of the present invention, the area region limiter is allocated to be displayed on the touch panel or is hidden within the touch panel.

According to an embodiment of the present invention, each subregion area element is correspondingly provided with an individual symbol element, wherein the symbol letters of each subregion area element is the same as the symbol letters of the corresponding the symbol element.

According to an embodiment of the present invention, in the step (c), it further includes a step of determining which direction that the finger sliding operation is passing through the subregion area elements.

According to an embodiment of the present invention, after the step (e), it further includes a step of inputting an input key as an input data while the finger sliding operation is determined as touching the subregion area elements and then touching the input key.

According to an embodiment of the present invention, the input key elements are distributed over different orientative position in orientations with respect to the area region limiter.

According to an embodiment of the present invention, the input key elements are displayed within an area surrounded by the area region limiter.

By means of technical means of the present invention, a group of the symbol keys belonging to a sub-touching area that is touched and is determined are displayed on the touch panel, so that a desired symbol key of the displayed group is further touched and determined from the displaying touch panel. Accordingly, it thus requires less number of steps of switching between different displaying pages to save time and turn the steps easier. In addition, the size of the symbol keys that are allowed to be displayed on the touch panel becomes larger to reduce the probability of fault input. Moreover, the method is more intuition-oriented and easier for operation for a user. So that a user can be easily, exactly, and rapidly input a symbol key into a touch panel device.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a flowchart illustrating the method according to an embodiment of the present invention;

FIG. 2 is a schematic diagram illustrating a touch panel device according to an embodiment of the present invention;

FIG. 3 is a block diagram illustrating a touch panel device according to an embodiment of the present invention;

FIG. 4 is a schematic diagram illustrating a keyboard input page of the touch panel device according to an embodiment of the present invention;

FIG. 5 is a schematic diagram illustrating a keyboard input page of the touch panel device according to an embodiment of the present invention;

FIG. 6 is a schematic diagram illustrating a keyboard input page of the touch panel device according to an embodiment of the present invention;

FIG. 7 is a schematic diagram illustrating a keyboard input page of the touch panel device according to an embodiment of the present invention;

FIG. 8 is a schematic diagram illustrating a keyboard input page of the touch panel device according to an embodiment of the present invention;

FIG. 9 is a schematic diagram illustrating a keyboard input page of the touch panel device according to an embodiment of the present invention;

FIG. 10 is a schematic diagram illustrating a keyboard input page of the touch panel device according to an embodiment of the present invention;

FIG. 11 is a schematic diagram illustrating a keyboard input page of the touch panel device according to an embodiment of the present invention;

FIG. 12 is a schematic diagram illustrating a keyboard input page of the touch panel device according to an embodiment of the present invention;

FIGS. 13A-13L are schematic diagrams illustrating area region limiters according to an embodiment of the present invention.

### DETAILED DESCRIPTION OF THE PREFERRED EMBODIMENTS

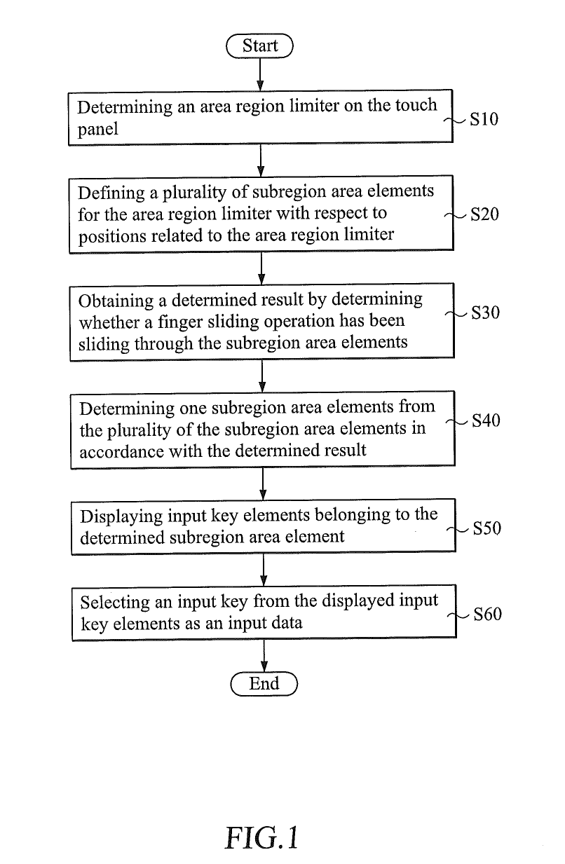

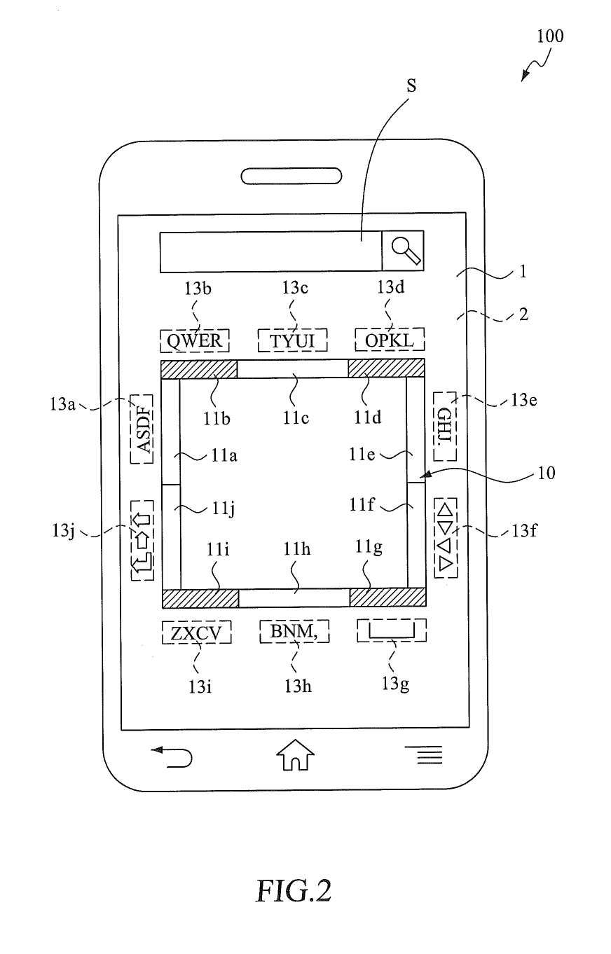

Referring to FIG. 1. FIG. 1 is a flowchart illustrating the method according to an embodiment of the present invention. And also refer to FIGS. 2-4. The method of the present invention is described as follows.

The method of the present invention includes steps of: determining an area region limiter on the touch panel (step S10); defining a plurality of subregion area elements for the area region limiter with respect to positions related to the area region limiter (step S20); obtaining a determined result by determining whether a finger sliding operation has been sliding through the subregion area elements (step S30); determining one subregion area elements from the plurality of the subregion area elements in accordance with the determined result (step S40); displaying input key elements belonging to the determined subregion area element (step S50); and selecting an input key from the displayed input key elements as an input data (step S60).

Specifically, in general, the method of the present invention is used for controlling a touch panel device 100. The touch panel device 100 may be a computer, a personal digital assistant, a digital watch, a satellite navigation device, or other devices with a touch panel.

In this embodiment, the touch panel device 100 has a touch panel 1, a displaying means 2, a position data storing means 3, and a hardware processing means 4. The displaying means 2 is coupled to the touch panel 1 and is stacked under the touch panel 1. The displaying means 2 has a visible area V for respectively displaying each individual page. In this embodiment, the displaying means 2 is a displaying screen, and the touch panel 1 is a transparent glass capacitive touch panel. A displaying page of the touch panel device 100 is displayed by passing the displaying page through the touch panel 1 from the visible area V of the displaying means 2. In other embodiments, the touch panel 1 also can be a resistive touch panel, an infrared ray touch panel, or the like. The position data storing means 3 electrically connects with the touch panel 1 and the displaying means 2, and the position data storing means 3 stores a position data of displaying information D1 that is for specifying a position of displaying information and a position data of subregion D2 that is for specifying a position of the subregion information. In this embodiment, the displaying means 2 is for displaying a plurality of pages. The position data of displaying information D1 is a data that is for specifying a position of the information to be displayed on each individual page by the displaying means 2. The position data of subregion D2 is for defining coordinative positions of subregion area elements 11a, 11b, 11c, 11d, 11e, 11f, 11g, 11h, 11i, 11j, as shown in FIG. 2, that are respectively allocated to each subregion area. The subregion area elements are located within an area region limiter 10. It thus the touch panel 1 has a plurality of subregion area elements 11a, 11b, 11c, 11d, 11e, 11f, 11g, 11h, 11i, 11j, where each element has its specific coordinative position in accordance with the position data of subregion D2 stored in the position data storing means 3. The position data of displaying information D1 and the position data of subregion D2 may be mutually related to each other or not. In this embodiment, the subregion area elements 11a, 11b, 11c, 11d, 11e, 11f, 11g, 11h, 11i, 11j are respectively provided with their individual symbol elements 13a, 13b, 13c, 13d, 13e, 13f, 13g, 13h, 13i, 13j, as shown in FIGS. 2, 4, 5, 6 and 8.

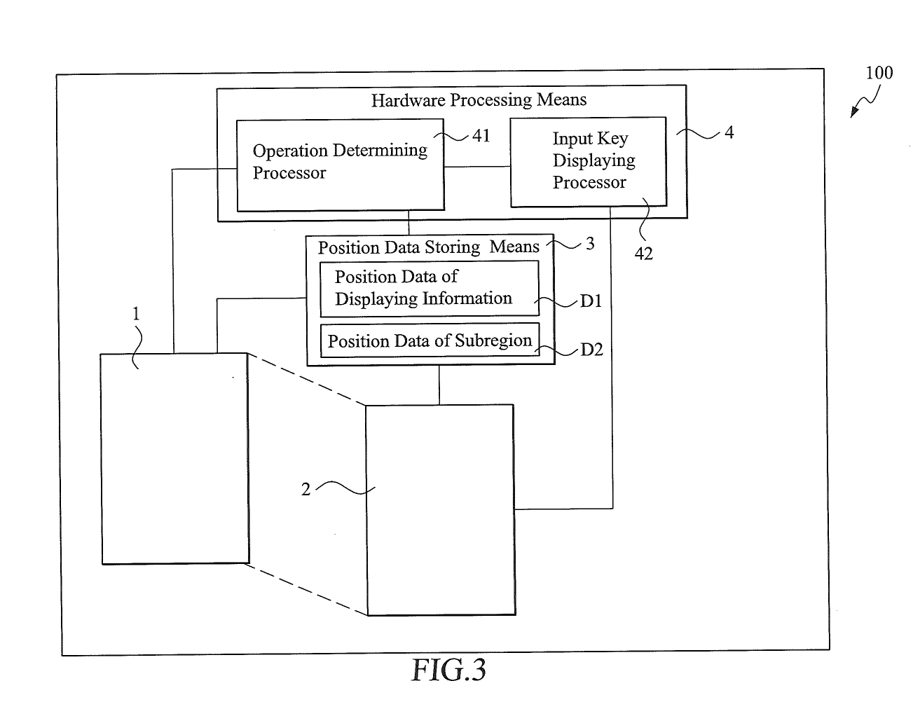

The control means 4, as referring to FIG. 3, includes an operation determining processor 41 and an input key displaying processor 42. The operation determining processor 41 electrically connects with the touch panel 1 and the position data storing means 3. The input key displaying processor 42 electrically connects with the operation determining processor 41 and the displaying means 2.

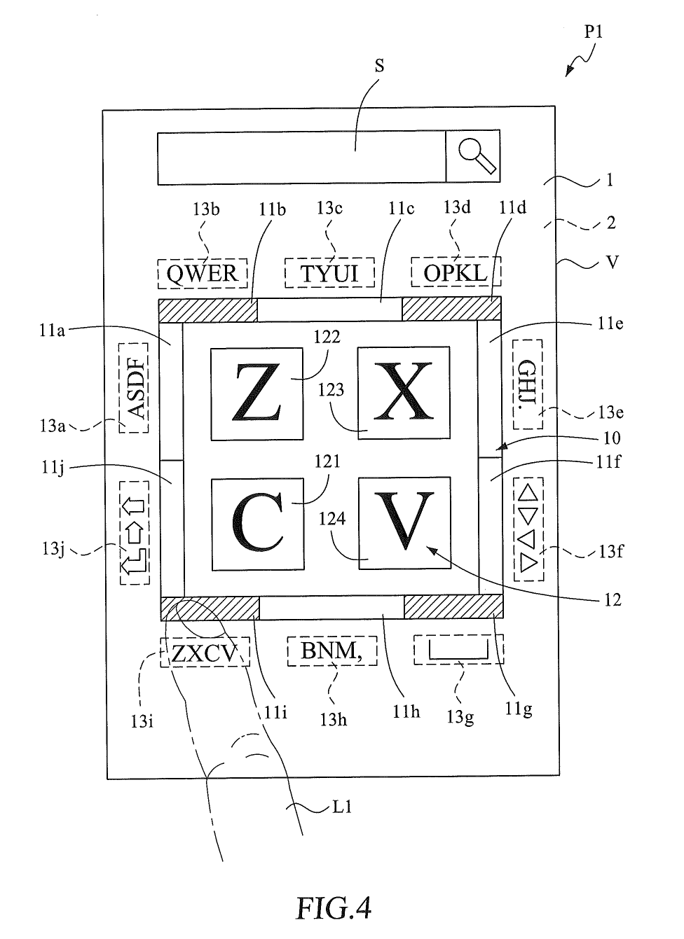

In the process of operation, the touch panel 1 is provided for detecting a finger sliding operation L1 of a touching movement of a user's finger (or a touch pen), as shown in FIG. 4. The operation determining processor 41 determines the finger sliding operation L1 regarding whether the user's finger slides through the subregion area elements 11a, 11b, 11c, 11d, 11e, 11f, 11g, 11h, 11i, 11j or not to thus obtain a determined result (step S30). The operation determining processor 41 determines one of the subregion area element from the plurality of the subregion area elements 11a, 11b, 11c, 11d, 11e, 11f, 11g, 11h, 11i, 11j in accordance with the determined result (step S40). Each subregion area element includes a plurality of input key elements. The input key displaying processor 42 displays the input key elements 12 in the touch panel 1. For an example as referring to FIG. 4, the input key elements 12 including input keys 121, 122, 123 and 124 that is belonging to the subregion area element 13i. Each subregion area element has its input key elements. The subregion area element is chosen and the corresponding input key elements are displayed on a main displaying area 15 of the touch panel 1, as in FIG. 4. In other words, the input key elements are determined by the operation determining processor 41 and are displayed (step S50), and the displayed input key elements are further chosen by a user in the main display area 15 as an input key (step S60).

The follows describes several pages of P1, P2, P3, P4, P5, P6, P7, P8, P9 while operation that are displayed by the displaying means 2 in the present invention for describing the method for inputting the input key elements.

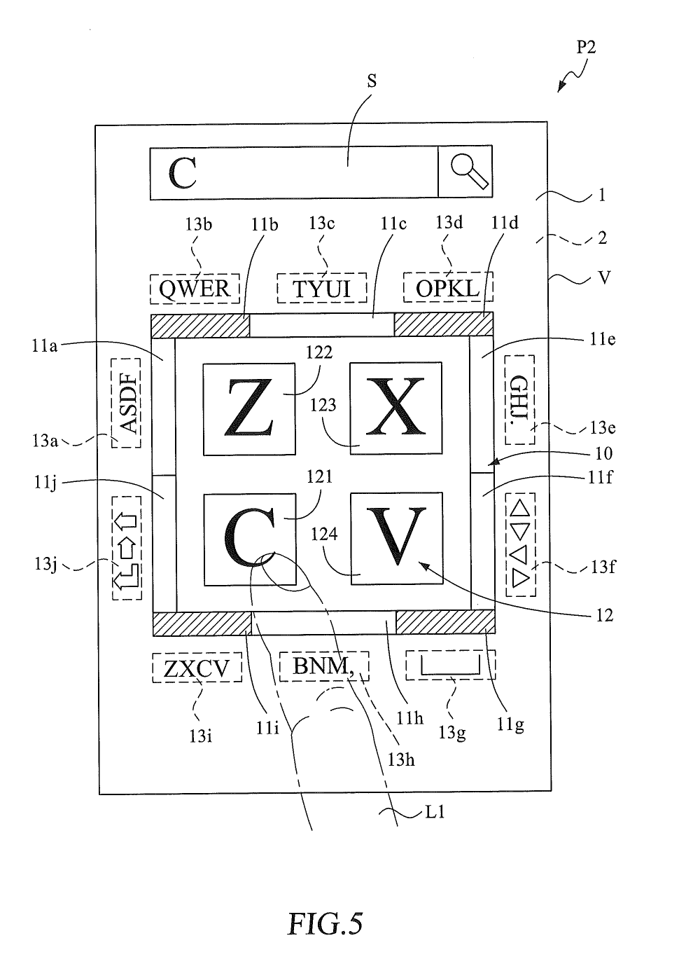

Referring to FIG. 4, as previously mentioned, in this embodiment, the touch panel 1 detects a finger sliding operation L1. The operation determining processor 41 determines whether the finger sliding operation L1 slides through the area region limiter 10 or not (step S30). When the operation determining processor 41 determines that the finger sliding operation L1 slides through the subregion area element 11i (step S40), the input key displaying processor 42 displays input key elements 12 that are corresponding to the subregion area element 11i, on the touch panel 1 (step S50). The input key elements 12 are displayed on the main displaying area 15, which is surrounded by the area region limiter 10. The symbols of input key elements 12 are the same as the symbols that belongs to a symbol element 13i of the subregion area element, and the size of the symbols of the input key elements 12 are larger than these of the symbol elements 13i. As an example by referring to FIG. 5, accordingly, an input key element 12 are displayed, and the input key element 121 with a symbol letter of “C” is clicked, so that the input key element 121 is input into an inputting field in searching box S (step S60), as show in the upper of FIG. 5.

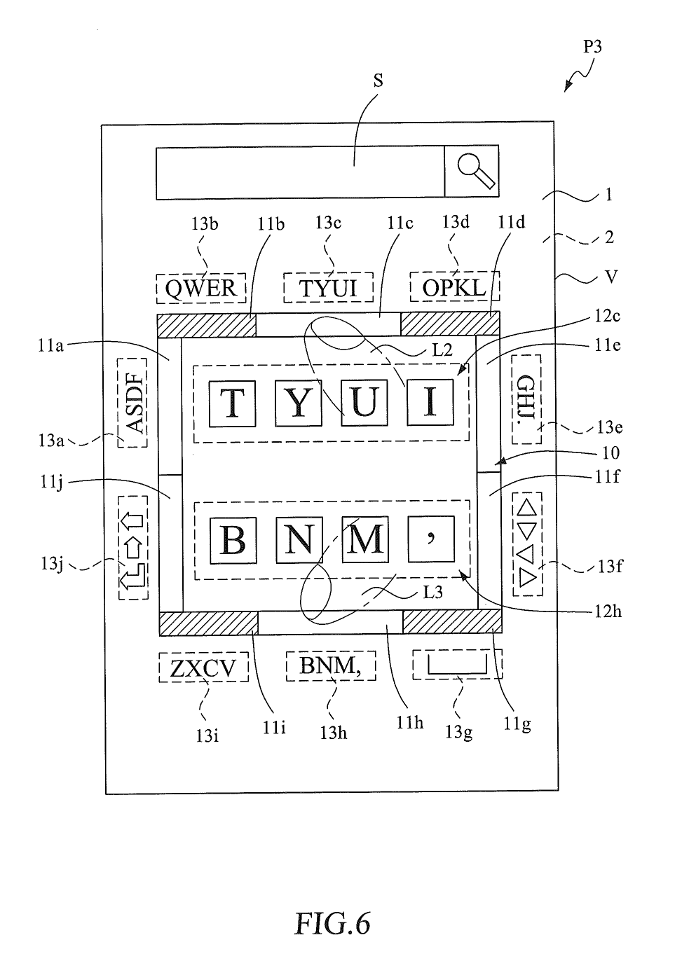

Referring to FIG. 6, as a preferred embodiment, the displaying means 2 can display a plurality of input key elements. In this embodiment, the touch panel 1 detects finger sliding operations L2, L3. The operation determining processor 41 determines whether the finger sliding operations L2, L3 slide through the area region limiter 10 or not (step S30). While the operation determining processor 41 determines that the finger sliding operation L2, L3 respectively slide through the subregion area elements 11c, 11h (step S40), a determined resulted is generated. In accordance with the determined result, the input key displaying processor 42 displays input key elements 12c, 12h, that are respectively corresponding to the subregion area elements 11c, 11h, on the touch panel 1 (step S50). Accordingly, the displayed two groups of input key elements 12c, 12h are displayed, and any one of input key element can be clicked by a user as an input key for being displayed on an inputting field of the searching box S (step S60).

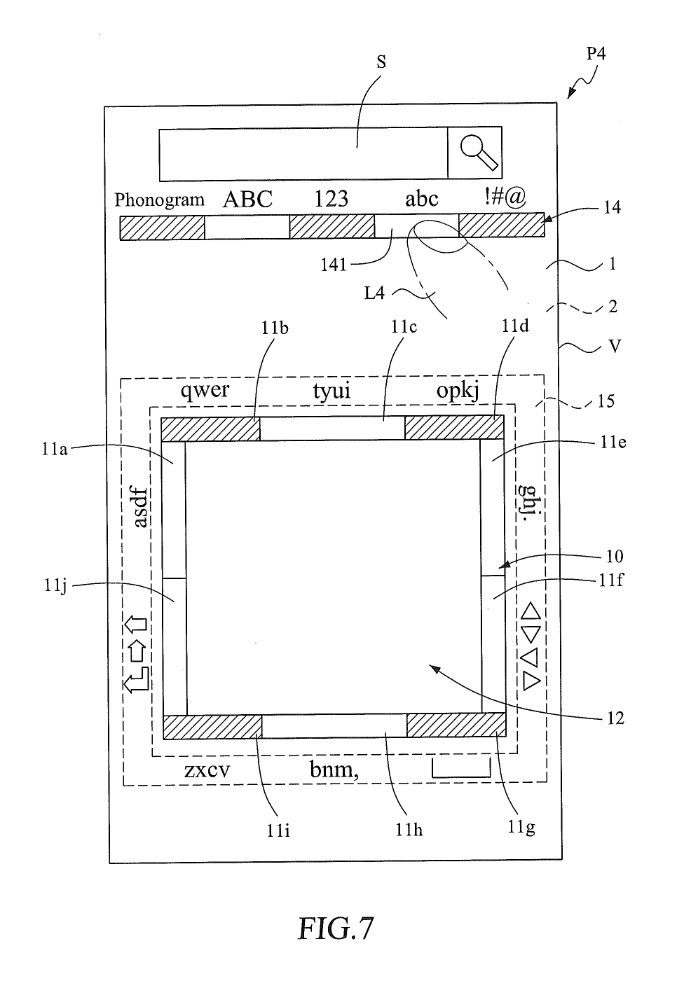

Referring to FIG. 7, as another embodiment for example, it further includes an input-type selecting elements 14. For example, when a finger sliding operations L4 of a user clicks on a lowercase locking element 141, the symbols of symbol elements 15 are turned to be shown as lowercase letters.

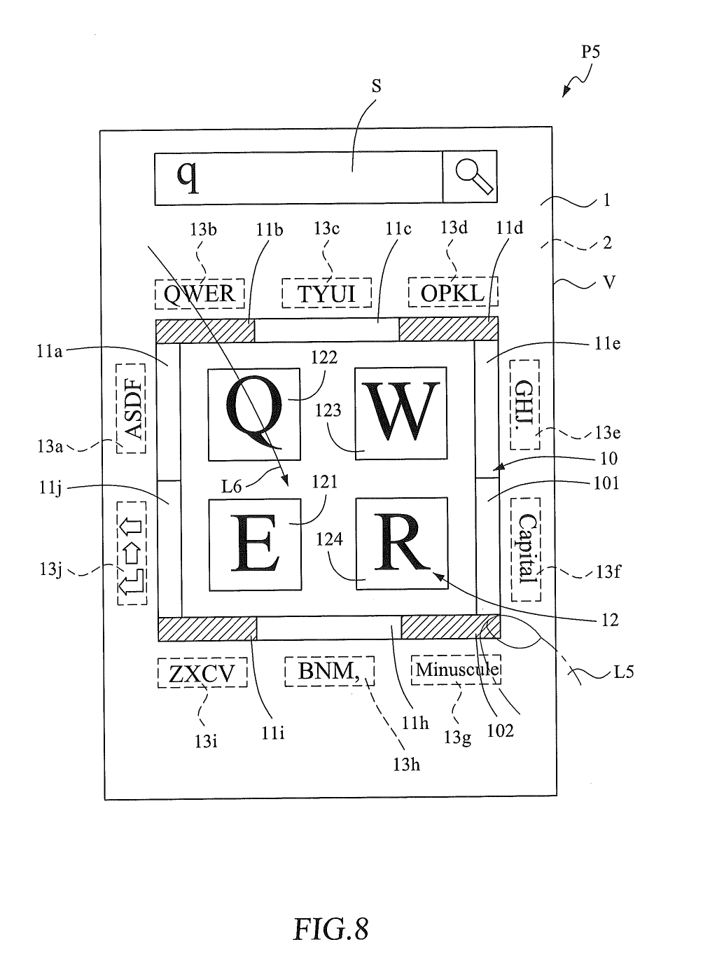

Referring to FIG. 8, as an example for another embodiment, two symbol elements for capitalization locking one and lowercase one are separately provided. The area region limiter 10 includes a capital locking element 101 and a lowercase locking element 102. When the operation determining processor 41 determines that the finger sliding operations L5 clicks on the lowercase locking member 102 and the subregion area element 11b is sliding through and the input key element 122, on which is lowercase of symbol letter “q” is clicked, then the input key element 122 is input into an inputting field in the searching box S (step S60).

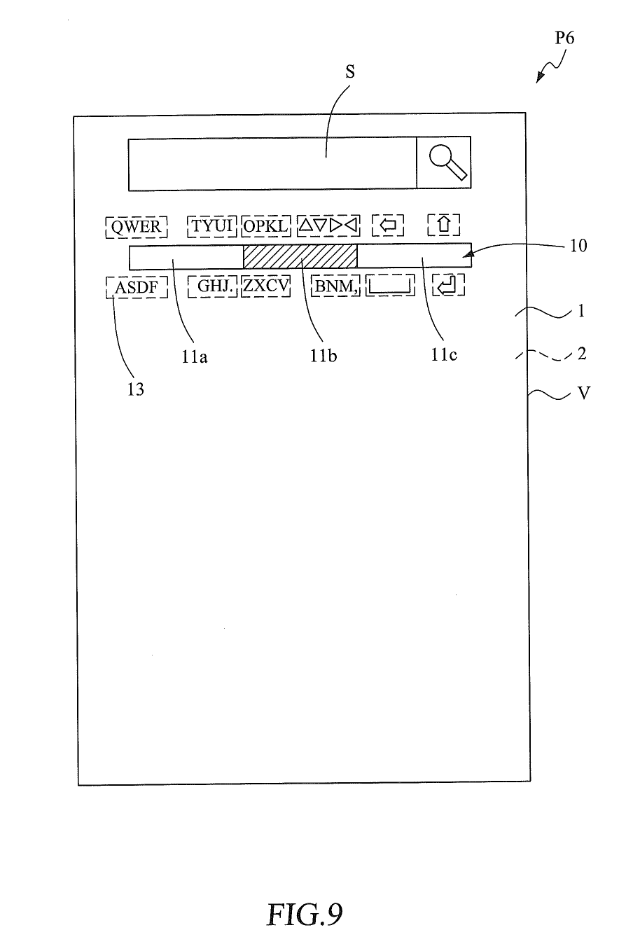

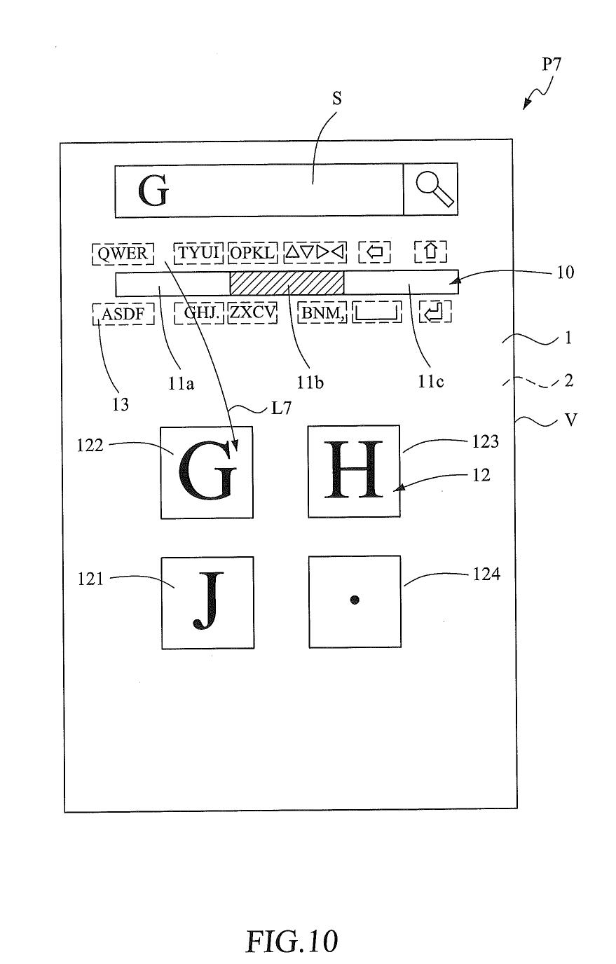

Referring to FIG. 9 and FIG. 10, as for another embodiment, one subregion area element 11a, 11b, 11c is corresponding to a plurality of the symbol elements 13. In this embodiment, in step S30, it further includes a step of determining sliding directions of user's finger with respect to the position of each subregion area elements 11a, 11b, 11c.

In a practical operation, when the finger sliding operation L7 touches the subregion area element 11a and slides with a direction toward a right side hand of a symbol element 13, where it indicates with symbol keys of “G”, “H”, “I” and “•”, it then displays the input key elements 12 of “G”, “H”, “I” and “•” in the main displaying area 15,

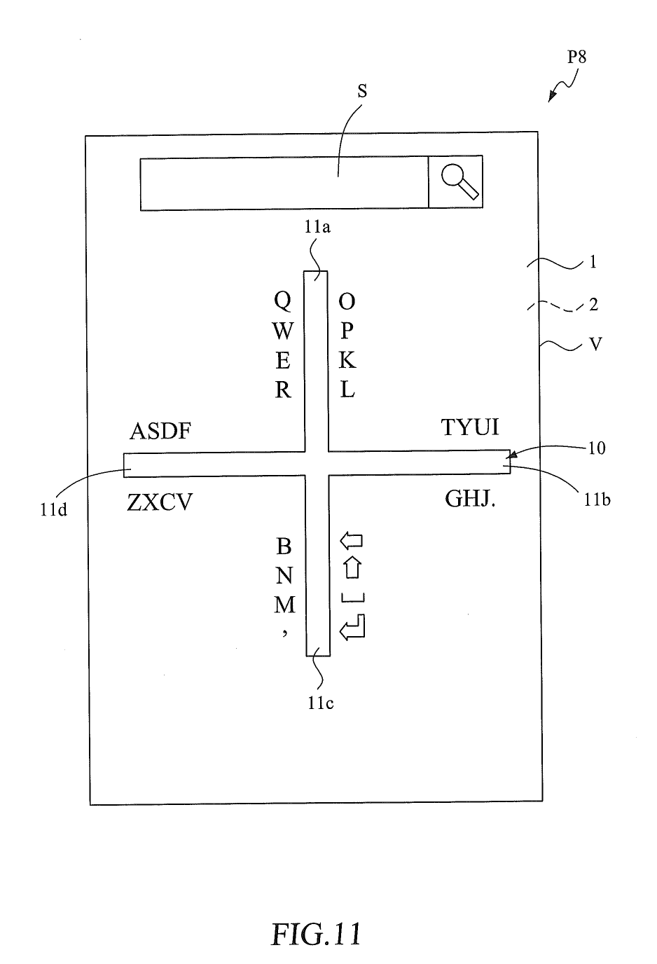

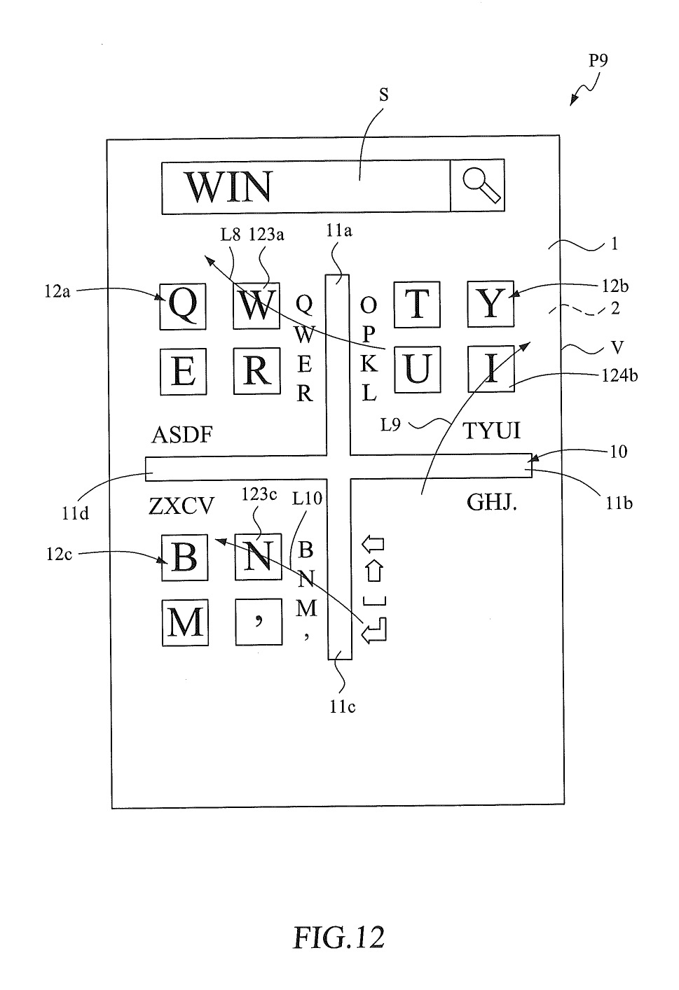

Referring to FIG. 11 and FIG. 12, as another embodiment, a plurality of the input key elements is equally distributed at various orientations with respect to an area region limiter 10. When the finger sliding operations L8, L9, L10 sequentially slide though the subregion areas elements 11a, 11b, 11c with specific directions respectively, several groups of input key elements including 12a, 12b and 12c are respectively displayed on the touch panel 1 for being selected. And then when the finger sliding operations L8, L9, L10 sequentially slide though input keys 123a, 124b, 123c, the touch panel device 100 sequentially input the letter “W” “I” “N” in an inputting field of a searching box S.

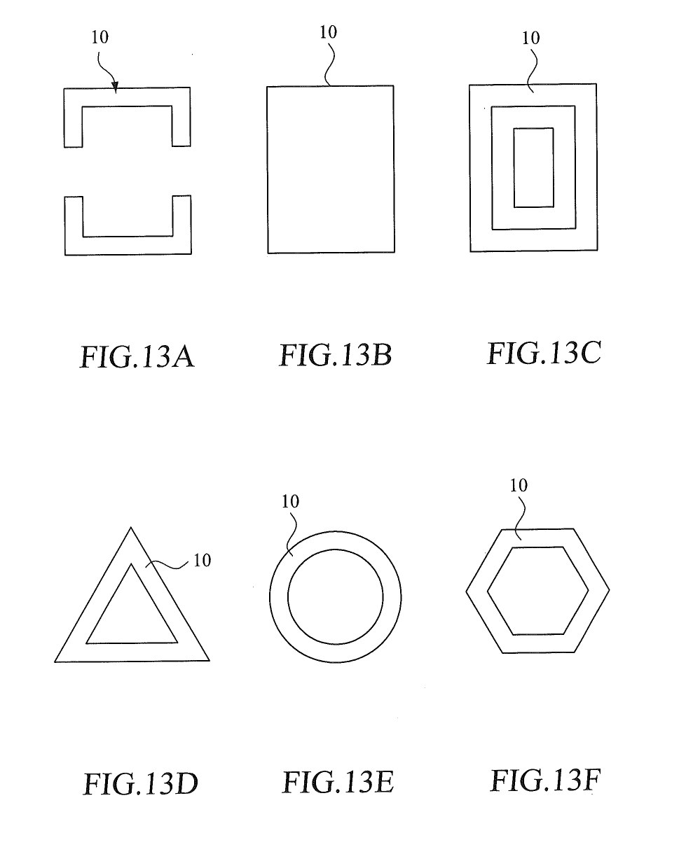

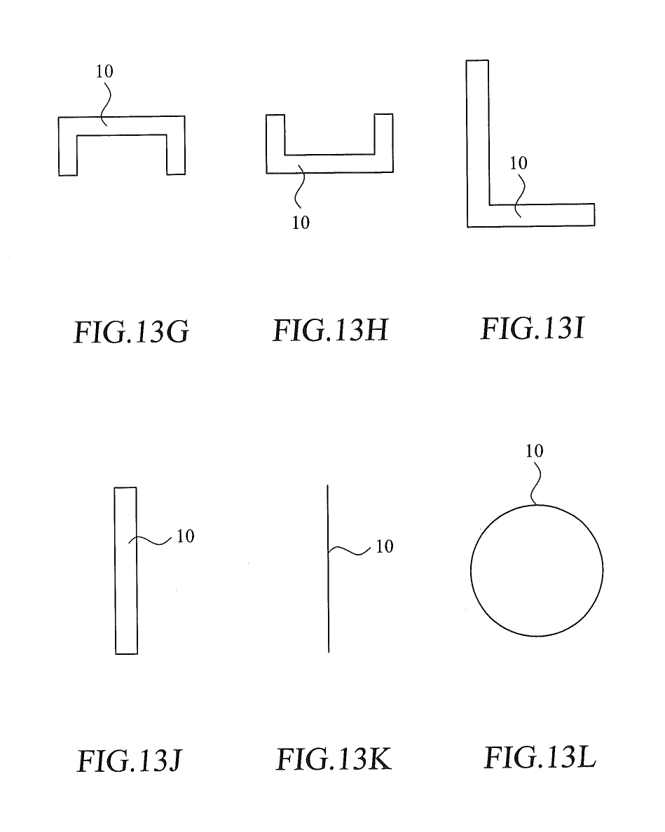

Of course, in addition to the shape of the area region limiter 10 as mentioned above, the shape of the area region limiter 10 of the present invention also can be the shape selected from a group including frame-shaped form, strip-shaped form, and spot-shaped form, as shown in FIGS. 13A-13L. And in other embodiments, the area region limiter 10 can be appeared on the touch panel or be hidden within the touch panel 1.

The above description should be considered as only the discussion of the preferred embodiments of the present invention. However, a person skilled in the art may make various modifications to the present invention. Those modifications still fall within the spirit and scope defined by the appended claims.

What is claimed is:

1. A method for data input of a touch panel device, for inputting input keys into a touch panel of the touch panel device, the method comprising steps of:
(a) determining an area region limiter on the touch panel;
(b) defining a plurality of subregion area elements for the area region limiter with respect to positions related to the area region limiter;
(c) obtaining a determined result by determining whether a finger sliding operation has been sliding through the subregion area elements;
(d) determining one subregion area elements from the plurality of the subregion area elements in accordance with the determined result;
(e) displaying input key elements belonging to the determined subregion area element; and
(f) selecting an input key from the displayed input key elements as an input data.

2. The method as claimed in claim 1, wherein the shape of the area region limiter is in shape as being selected from a group including frame-shaped form, strip-shaped form, and spot-shaped form.

3. The method as claimed in claim 1, wherein the area region limiter is allocated to be displayed on the touch panel or is hidden within the touch panel.

4. The method as claimed in claim 1, wherein each subregion area element is correspondingly provided with an individual symbol element, wherein the symbol letters of each subregion area element is the same as the symbol letters of the corresponding the symbol element.

5. The method as claimed in claim 1, wherein in the step (c), it further includes a step of determining which direction that the finger sliding operation is passing through the subregion area elements.

6. The method as claimed in claim 1, wherein after the step (e), it further includes a step of inputting an input key as an input data while the finger sliding operation is determined as touching the subregion area elements and then touching the input key.

7. The method as claimed in claim 1, wherein the input key elements are distributed over different orientative position in orientations with respect to the area region limiter.

8. The method as claimed in claim 1, wherein the input key elements are displayed within an area surrounded by the area region limiter.
